(19) United States
(12) Patent Application Publication
(10) Pub. No.: US 2005/0225759 A1
(43) Pub. Date: Oct. 13, 2005

(54) Method and device for viewing a burner flame

(76) Inventors: Emil Edwin, Trondheim (NO); Tore Arnesen, Ranheim (NO)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/510,838

(22) PCT Filed: Apr. 11, 2002
(86) PCT No.: PCT/EP02/04044

§ 371 Date: May 18, 2005

(51) Int. Cl. G01J 3/28

(52) U.S. Cl. 356/328

(57) ABSTRACT

A method of viewing the flame produced by a burner in a furnace in provided, comprising viewing the flame through an interference filter adapted to pass light of only a narrow wavelength range, in which the wavelength range corresponds to a wavelength which is stronger in the light emitted by the burner than in the ambient light of the furnace. The method is particularly applicable to viewing the flames produced by natural gas burners in petroleum crackers and the preferred wavelength range is that of sodium.

The present invention relates to a method and apparatus for viewing a flame in a furnace, such as for example a burner flame in the pyrolysis section of a petrochemical cracker reactor.

In a petroleum cracker, large hydrocarbon molecules such as ethane and propane from natural gas, or heavier liquids such as naphta and gas oil from petroleum are split into smaller molecules. This is often done to provide olefins such as ethylene that are useful in themselves, or may be used in polymerisation processes.

In the case of ethane and propane, the gas is heated to above about 800° C. at which point bonds within the molecule break, producing a range of smaller molecules. The desired products are then separated out. The same principle applies when cracking heavier substances, but since the molecules are much larger, a far greater range of smaller molecules is provided. Although some processes provide a smaller yield of olefins, many other useful by-products are produced.

In a typical ethane cracker plant, the cracking takes place in a pyrolysis section. Here, ethane is pumped through a maze of 100-150 mm diameter tubes located within a furnace where it is heated up to about 800° C. and cracks. The ethane never comes into direct contact with the source of heat, if it were to do so it would ignite disastrously.

Typically, the pyrolysis section includes a plurality of burners which are positioned adjacent the tubes through which the ethane is pumped. The burners combust a fuel such as natural gas in order to heat the gas in the tubes to the required temperature.

To achieve maximum thermal efficiency of the cracker the flame from each of the burners should be maintained at the required size and orientation. This can be done by adjusting the quantity of fuel supplied to the burner and/or by adjusting the ratio of fuel supplied to air and/or by adjusting the direction of the jets of fuel.

In order to monitor the size and orientation of the burner flames, an operator views the flames at regular intervals and then makes any adjustments which may be required. However, the heat in the pyrolysis section is such that the walls of the cracker are heated to a temperature of about 1100° C. Consequently, radiant beat is given off from the walls to create a bright background against which it is very difficult to see the burner flames.

In the past, this problem has been overcome by adding either copper or sodium bicarbonate to the flames to provide a colour which is visible against the bright background of the walls of the cracker. To do this however, the pyrolysis chamber must be opened up and the copper or sodium bicarbonate thrown into the flames. It will be appreciated that at the operating temperatures in question this is a complex procedure which results in significant inconvenience and energy losses.

The present invention seeks to provide a method of viewing the flames of the burners in a furnace such as the pyrolysis chamber of a cracker which can be carried out quickly and easily and without the need to lose heat from the furnace.

The applicants have realised that if the light emitted by the burner flames or a part of that light could be separated from the background radiant light in the furnace, the burner flames could then be viewed without the need for complex solutions such as throwing additives into the flames.

From a first aspect, the present invention provides a method of viewing the flame produced by a burner in a furnace, wherein the fuel burnt by the burner is natural gas, comprising viewing the flame through an interference filter adapted to pass light of the wavelength of sodium only.

Thus, the interference filter acts to block out the bulk of the abient light of the furnace such that the burner flame is clearly visible.

In one preferred embodiment of the invention, the furnace is the pyrolysis section of a petroleum cracker.

The method is particularly advantageous in such an environment as the walls of the cracker are heated to a very high temperature such that they emit significant levels of white light which makes it difficult or eves impossible to see the flame of a burner in the cracker under normal circumstances.

Typically, the fuel which is burnt in the petroleum cracker is natural gas and most typically, a mixture of hydrogen, methane and air. Tests have shown that this fuel can contain traces of sodium. The reason for this is not known but it is thought to be because methane and natural gas often come from environments in which salt is present. In the method of the invention therefore, the filter used is a sodium interference fitter which filters out substantially all the light other than the sodium light emitted by the sodium trace elements in the fuel.

Preferably the sodium interference filter has a pass bandwidth of approximately 10 nm so that light of wavelength 0.584 to 0.594 μm may pass through the filter. More preferably the pass bandwidth is 2 to 5 nm and, still more preferably, the pass bandwidth is 1 nm so that only light of wavelength 0.589 μm passes through the filter.

The use of a sodium interference filter is particularly advantageous as there is effectively no light of the wavelength of sodium present as ambient light in the furnace such that the burner flame is very clearly visible using this method.

The sodium interference filter could take any form and the burner in the furnace could be viewed through a door which is opened in use as in known systems. Preferably however, a window is provided in the wall of the furnace through which the burner can be viewed. This has the advantage that the furnace does not need to be opened each time that the burners are viewed. Thus the temperature inside the furnace is not disturbed and thermal currents which can distort the action of the burner flame are not created by opening and closing the furnace at regular intervals.

Preferably, the window is made of quartz which is a material capable of withstanding the temperature gradient across the wall of the furnace while also providing the necessary transparency.

In one preferred embodiment, the interference filter could be provided as a panel attached to the window of the furnace.

Still more preferably, the filter in a panel which can be placed over the window or removed by a user as required. Thus for example, the filter could be hinged to the wall of the furnace to allow quick and easy adjustment thereof.

In an alternative embodiment, a pair of glasses or goggles comprising an interference filter in each lens thereof is provided. This has the advantage of allowing a user to carry the glasses with him for example from one furnace to the next. The goggles have the additional advantage that they could also be used with a traditional furnace in which no sealed window is provided but a door is merely opened when a user wishes to look inside the furnace.

In a still further preferred embodiment of the invention, the interference filter could be provided in a camera arranged inside the furnace and adapted to photograph the burner at regular intervals. The information from the camera could then be relayed to an operator who could make any necessary adjustments to the burner from a remote location. This would clearly be advantageous in a large scale refinery or similar scale production plant where considerable numbers of personnel would be required to monitor the operation of each furnace in situ.

Ideally the camera could be programmed to photograph the burner about once every 10 minutes.

It will be appreciated that the furnace would normally include a plurality of burners and, in the case of a petroleum cracker, ten or more burners could be provided. Thus if necessary, the camera could be programmed to move along a row of burners and to take several pictures of respective burners or groups thereof.

From a further aspect, the present invention provides an apparatus comprising a furnace, a burner for burning natural gas in the furnace and an apparatus for viewing the flame produced by the burner, the apparatus for viewing the flame comprising an interference filter adapted to pass light of the wavelength of sodium only.

In one preferred embodiment, the apparatus further comprises a window provided in the wall of the furnace through which the burner can be viewed.

Preferably, the window is made of quartz.

In one preferred embodiment, the interference filter could be provided as a panel attached to the sealed window of the furnace.

Still more preferably, the filter is a panel which can be placed over the window or removed by a user as required. Thus for example, the filter could be hinged to the wall of the furnace to allow quick and easy adjustment thereof.

The provision of a panel over the window is considered to be novel and inventive in its own right and so, from a further aspect, the present invention provides a furnace comprising a burner housed within the walls thereof and a window provided in a wall of the furnace, wherein am interference filter adapted to pass light of only a narrow wavelength range is provided in or on the window.

In an alternative embodiment, the apparatus comprises a pair of glasses or goggles comprising an interference filter in each lens thereof.

The provision of such goggles is also considered to be novel and inventive in its own right and so, from a further aspect, the present invention provides glasses comprising an interference filter provided in each lens thereof, wherein the interference filter is adapted to pass light of the wavelength of sodium only.

In another alternative embodiment of the invention, the apparatus comprises a camera in which the interference filter is provided, wherein the camera is arranged inside the furnace and adapted to photograph the burner at regular intervals. The information from the camera could then be relayed to an operator who could make any necessary adjustments to the burner from a remote location.

Ideally the camera could be programmed to photograph the burner about once every 10 minutes.

It will be appreciated that the furnace would normally include a plurality of burners and, in the case of a petroleum cracker, ten or more burners could be provided. Thus if necessary, the camera could be programmed to move along a row of burners and to take pictures of respective burners or groups thereof.

Preferred embodiments of the invention will now be described, by way of example only, and with reference to the accompanying drawings in which:

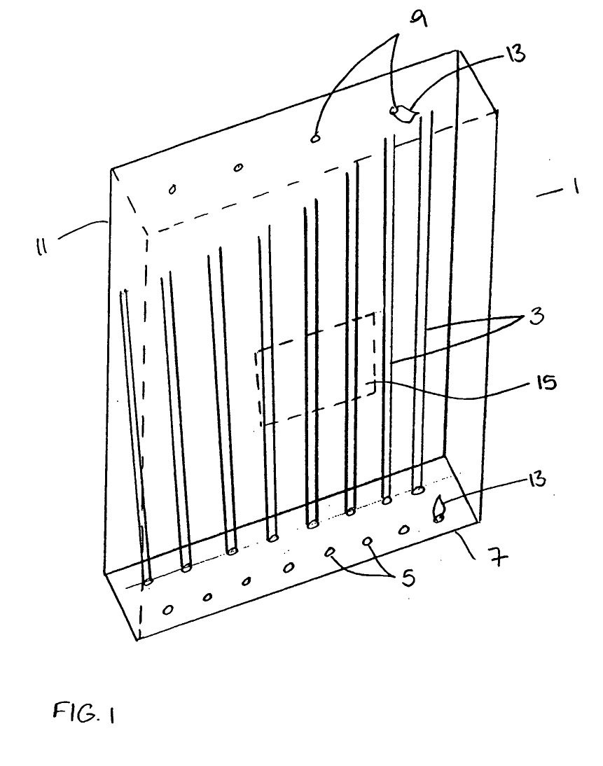

FIG. 1 schematically shows a pyrolysis section of a petroleum cracker; and

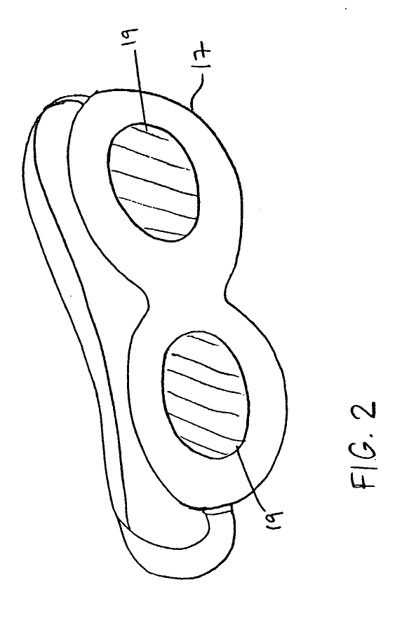

FIG. 2 shows a pair of goggles according to one embodiment of the invention.

As shown in FIG. 1, a petroleum cracker includes a pyrolysis section 1 in which petroleum is heated in order to carry out the cracking process. The pyrolysis section includes a number of pipes or tubes 3 through which the petroleum flows in use. Burners 5 are provided in the base 7 of the pyrolysis section and further burners 9 are also provided in the rear wall 11. The burners 5, 9 burn a mixture of hydrogen, air and methane supplied to them by a pipe network (not shown).

The burners each produce a naked flame 13, the size and orientation of which must be controlled in order to ensure even heating of the petroleum pipes 3. In order to monitor the size and orientation of the flames 13, a window 15 made of quartz is provided in a wall of the pyrolysis section. The window is sealed so that the temperature and stability of the burner flames inside the pyrolysis section are not affected by air currents from the window.

As shown in FIG. 2, goggles 17 are provided to be worn by a user when viewing the flames 13. A sodium interference filter 19 is provided in each lens of the goggles as shown. The sodium interference filters have a pass band of approximately 1 nm so that only light of wavelength 0.589 μm passes through the filters. Thus, when a user wearing the goggles views the flames 13 of the burners 5, 9 through the window 15, only light from sodium trace elements in the burner flames is visible and the ambient light from the walls of the pyrolysis section which glow white hot is filtered out. Thus, the user can see the flames clearly and so can determine whether any adjustment to their size and/or orientation is required.

Any adjustments to the burner flames which are required are carried out by adjusting the quantity of fuel supplied to individual burners and/or the ratio of air to fuel supplied to the burners and/or by adjusting the direction of the jet of fuel emitted by the individual burners.

It will be appreciated that the embodiment of the invention described above is only a preferred embodiment thereof. Thus many variations could be made thereto without departing from the scope of the invention as claimed. For example, the interference filters provided could have a pass band of different wavelength, corresponding for example to the wavelength of another trace element in the burner flames. Further, the interference filter could be provided in or on the window to the furnace itself or in a camera arranged inside the furnace rather then in the goggles described above.

It will therefore be appreciated that the above description is given by way of example only and is not intended to be limiting.

1. A method of viewing the flame produced by a burner in a furnace, wherein the fuel burnt by the burner is natural gas, comprising viewing the flame through an interference filter adapted to pass light of the wavelength of sodium only.

2. A method as claimed in claim 1, wherein the furnace is the pyrolysis section of a petroleum cracker.

3. A method as claimed in claim 1, wherein the fuel burnt by the burner is a mixture of hydrogen, methane and air.

4. A method as claimed in claim 1, wherein a window is provided in the wall of the furnace through which the burner flame can be viewed.

5. A method as claimed in claim 4, wherein the window is made of quartz.

6. A method as claimed in claim 4, wherein the interference filter is provided as a panel attached to the window of the furnace.

7. A method as claimed in claim 6, wherein the panel is hinged to the furnace so it can be placed over the window or removed by a user as required.

8. A method as claimed in claim 1, wherein a pair of glasses or goggles having an interference filter in each lens thereof is provided.

9. A method as claimed in claim 1, wherein the interference filter is provided in a camera arranged inside the furnace and adapted to photograph the burner at regular intervals.

10. A method as claimed in claim 9, wherein the information from the camera is relayed to an operator who makes any necessary adjustments to the burner from a remote location.

11. A method as claimed in claim 9, wherein the camera is programmed to photograph the burner about once every 10 minutes.

12. A method as claimed in claim 9, wherein the camera is programmed to move along a row of burners and to photograph groups of one or more burner flames in turn.

13. An apparatus comprising a furnace, a burner for burning natural gas in the furnace and an apparatus for viewing the flame produced by the burner, the apparatus for viewing the flame comprising an interference filter adapted to pass light of the wavelength of sodium only.

14. An apparatus as claimed in claim 13, wherein a window is provided in the wall of the furnace through which the burner flame can be viewed.

15. An apparatus as claimed in claim 14, wherein the window is made of quartz.

16. An apparatus as claimed in claim 14, wherein the interference filter is provided as a panel attached to the window of the furnace.

17. An apparatus as claimed in claim 14, wherein the filter is a panel which can be placed over the window or removed by a user as required.

18. An apparatus as claimed in claim 13, wherein the apparatus for viewing the flame comprises a pair of glasses or goggles comprising an interference filter in each lens thereof.

19. An apparatus as claimed in claim 13, wherein the apparatus for viewing the flame comprises a camera in which an interference filter is provided, wherein the camera is arranged inside the furnace and adapted to photograph the burner flame at regular intervals.

20. An apparatus as claimed in claim 19, comprising means for relaying the information from the camera to an operator and means for making any necessary adjustments to the burner from a remote location.

21. An apparatus as claimed in claim 19, wherein the camera is programmed to photograph the burner about once every 10 minutes.

22. An apparatus as claimed in claim 19, wherein the camera is programmed to move along a row of burners and to photograph groups of one or more burner flames in turn.

23. A furnace comprising a burner for burning natural gas housed within the walls thereof and a window provided in a wall of the furnace, wherein an interference filter adapted to pass light of the wavelength of sodium only is provided in or on the window.

24. Glasses comprising an interference filter provided in each lens thereof, wherein the interference filter is adapted to pass light of the wavelength of sodium only.
